(19) United States
(12) Patent Application Publication
(10) Pub. No.: US 2004/0011930 A1
(43) Pub. Date: Jan. 22, 2004

(54) Bucket support device

(76) Inventors: Dennis J. Tuohy III, Newton, NJ (US); Jeannie Touhy, Newton, NJ (US)

Correspondence Address: STEVEN B. STEIN, ESQ., STEIN & STEIN, 164 ROUTE 10 WEST, SUCCASUNNA, NJ, 07876, US

(21) Appl. No.: 10/199,780

(22) Filed: Jul. 19, 2002

(51) Int. Cl. A47G 23/02; F16M 11/00

(52) U.S. Cl. 248/146; 248/150; 248/163.1

(57) ABSTRACT

The present invention provides a bucket support device comprising: (a) a stand; (b) a vertically disposed central telescoping rod, the rod comprising a first end attached to the stand, and a second end; (c) a horizontally disposed flat support platform, the support platform comprising a bottom surface stably attached to second end of the rod, and a top surface; (d) a bucket comprising a horizontal base and vertical side walls, the bucket horizontal base stably attached to the top surface of the support platform by a bucket attachment means; and (e) a bucket attachment means.

Throughout this application, various publications are referenced. Full citations for these publications may be found listed at the end of the specification and preceding the claims. The disclosures of these publications in their entireties are hereby incorporated by reference into this application in order to more fully describe the state of the art.

### FIELD OF THE INVENTION

The above-identified invention involves the field of container support devices in general and specifically relates to a bucket support device capable of telescopically positioning a platform capable of stably supporting a load. More specifically, the invention involves a device suitable for telescopically positioning a bucket such as a paint can or tool container at variable heights.

### BACKGROUND OF THE INVENTION

The present invention provides a mobile bucket support device, capable of positioning and supporting a container, such as a paint can to variable heights.

Examples of vertical load supporting devices are well known in the prior art. In most cases, these devices are cumbersome to use and take time to reset and reposition. While useful for bearing substantial vertical loads, they fail to provide a quick and easy way for a worker to rapidly access materials at various particular vertical heights. In particular, a painter working along a ceiling or a worker using a variety of tools along the top of a surface requires quick and easy repositioning of materials at a height. The prior art devices use complicated mounting arrangements and complicated lifting mechanisms. Other prior art devices are subject to moving out of position because they are cannot be securely mounted. Still other prior art devices, once mounted, impede easy and variable height adjustment. The present invention solves the problems of the prior art.

### SUMMARY OF THE INVENTION

It is therefore an object of the present invention to provide a bucket support device comprising: (a) a stand; (b) a vertically disposed central telescoping rod, the rod comprising a first end attached to the stand, and a second end; (c) a horizontally disposed flat support platform, the support platform comprising a bottom surface stably attached to second end of the rod, and a top surface; (d) a bucket comprising a horizontal base and vertical side walls, the bucket horizontal base stably attached to the top surface of the support platform by a bucket attachment means; and (e) a bucket attachment means.

### BRIEF DESCRIPTION OF THE DRAWINGS

FIG. 1: View of the provided bucket support device in telescopically collapsed position with tripod stand in non-retracted position.

FIG. 2: View of the provided bucket support device in telescopically extended position with tripod stand in non-retracted position.

FIG. 3: View of the underside of the provided bucket and provided bucket support platform.

FIG. 4: View of the provided bucket support device showing cut away view of telescopically inserted rod segments.

FIGS. 5A-C: View of the provided bucket support device showing the Bucket (FIG. 5A); the Central Telescoping Rod (FIG. 5B); and the Stand (FIG. 5C).

### DETAILED DESCRIPTION

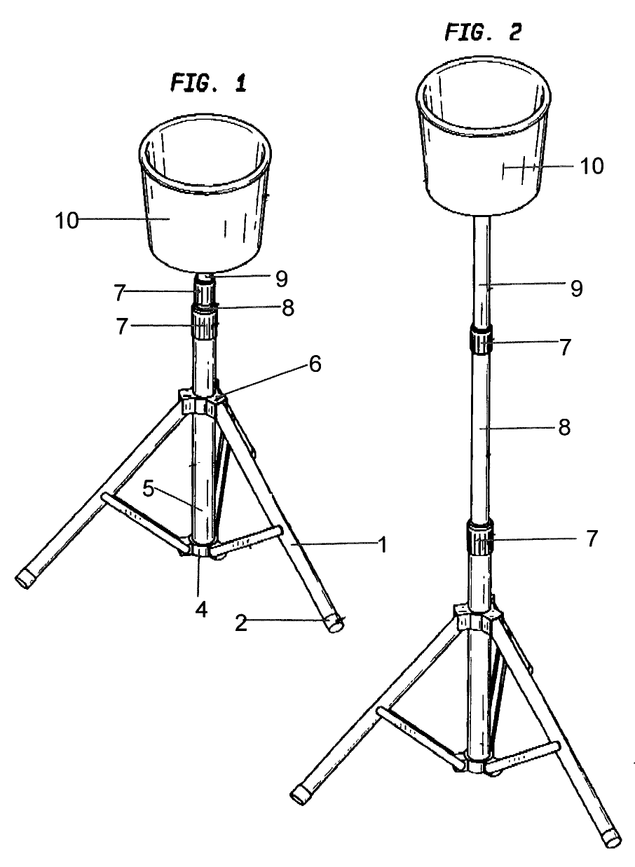

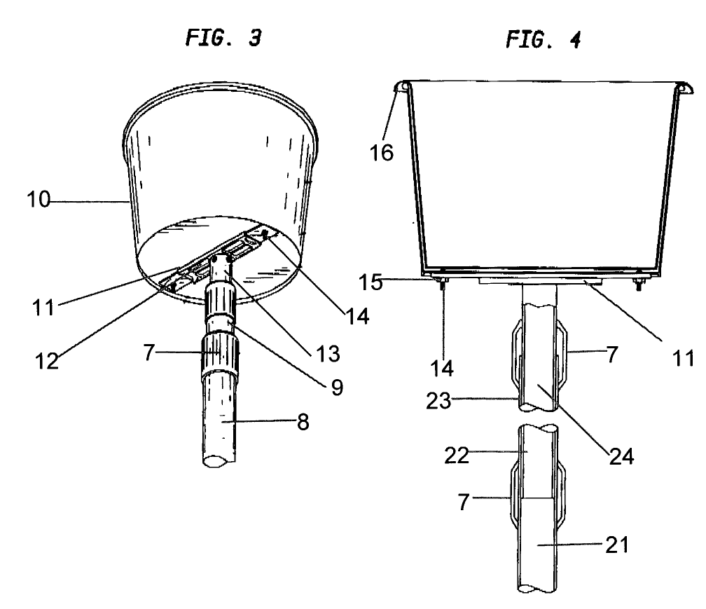

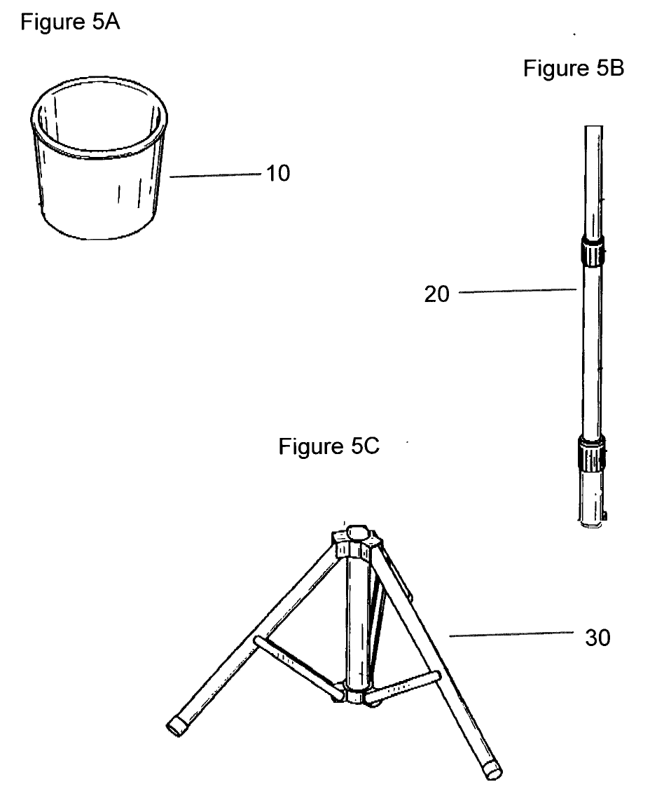

Referring now to the drawings (FIGS. 1-5) wherein like numerals refer to like and corresponding parts throughout the several views, the present invention provides a bucket support device comprising: (a) a stand 30; (b) a vertically disposed central telescoping rod 20, the rod comprising a first end attached to the stand, and a second end; (c) a horizontally disposed flat support platform 11, the support platform comprising a bottom surface stably attached to second end of the rod, and a top surface; (d) a bucket 10 comprising a horizontal base and vertical side walls, the bucket horizontal base stably attached to the top surface of the support platform by a bucket attachment means 14, 15; and (e) a bucket attachment means. According to one embodiment of the invention, the provided stand further comprises a plurality of legs 1. According to another embodiment of this invention, the stand is a tripod. According to still another embodiment of the invention, the stand is retractable. According to a further embodiment of the invention, the stand is collapsible. According to a still further embodiment of the invention, each leg comprises a plurality of leg segments, telescopically connected. Still further, according to another embodiment of the invention, the stand is attached to a central ring 4. According to an embodiment of this invention, the stand further comprises a slidable upper ring 6 capable of inserting about the central rod 20. According to another alternate embodiment, the stand is a solid base. Even further still, according to an embodiment of the invention, the stand further comprises a plurality of rollers. According to one embodiment of this invention, the rollers further comprise wheels capable of facilitating horizontal movement of the provided bucket support device. According to a further embodiment of this invention, the roller further comprises an integrated braking device capable of immobilizing the roller. According to an alternate embodiment of this invention, the rollers are not mobile and take the form of a friction cover stopper 2 such as a boot. According to another alternative embodiment, the roller is a friction reducing cover capable of horizontally sliding the provided bucket support device.

Moreover, according to another embodiment of the invention, the central telescoping rod 20 further comprises a plurality of rod segments 5, 8, 9, 13, telescopically interconnected. Telescopically interconnected means that an insertion end of one rod segment 22, 24 slidingly inserts into a receiving end of a second rod segment 21, 23 thereby varying the overall length of the combined rod segments. For example, a first rod segment slidingly inserted fully into a second rod segment is of a shorter length than that of a first rod segment slidingly inserted partially into a second rod segment (Compare FIG. 1 and FIG. 2). Because the rod segments are vertically disposed, the overall vertical height of the combined rod segments is variable. According to yet another embodiment of the invention, the central telescoping rod further comprises a rod slide-stabilizing device 7, capable of securing the vertical position of the telescoping rod at a specific position. Accordingly, rod segments are vertically stabilized with respect to each other by means of the rod slide-stabilizing device. The rod slide-stabilizing devices arrests movement between the rod segments with respect to each other. The rod slide-stabilizing device thereby stably facilitates rapid resetting of the vertical position of the central telescoping rod. According to one preferred embodiment of this invention, the rod slide-stabilizing device is rotatable about the rod, thereby tightening the receiving end of one rod segment about the insertion end of the second rod segment, thereby preventing vertical sliding of the telescoping rod. According to an alternate preferred embodiment of this invention, the rod-slide-stabilizing device is a lever-activated device, the lever tightening the device about the rod, tightening the receiving end of one rod segment about the insertion end of the second rod segment, thereby preventing vertical sliding of the telescoping rod. According to still another alternate embodiment of this invention, the rod slide-stabilizing device is a pin inserted through fixed horizontally aligned openings in the rod, thereby preventing vertical sliding of the telescoping rod. According to still another alternate embodiment, the rod slide-stabilizing device is an adjustable screw-type fastener. According to still another alternate embodiment, the rod slide-stabilizing device is a cleat, which grabs the outside surface of the rod. According one embodiment of the present invention, the rod is a hollow tube.

According to yet another embodiment of the invention the horizontally disposed flat support platform 12 further comprises a central opening compatible with the bucket attachment means 14, 15. The present invention contemplates an attachment means including a fastener, bolt, pin, rivet screw and nut. Still yet another embodiment of the invention is wherein the horizontally disposed flat support platform further comprises a plurality of openings 12. Even yet another embodiment of the invention is wherein the horizontally disposed flat support platform is a washer. According to an alternate embodiment of this invention, the support platform is disposed inside the bottom of the bucket. According to still another alternate embodiment of this invention, a plurality of support platforms is disposed inside and outside the bottom of the bucket. According to still another embodiment of this invention, the support platform is horizontally elongated so as to protrude beyond the outside edge of the bucket. Openings within the protruding portion of the elongated platform are capable of receiving various tools and implements. According to another embodiment of the invention, the bucket further comprises a liner insert 16. The liner insert is comprised of material selected from the group including plastic, cloth, canvas, rubber wood and metal. Additionally, another embodiment of the invention is wherein the liner further comprises a storage compartment. According to an embodiment of this invention, the storage compartment hangs over the top outside wall of the bucket 10 and is capable of storing tools and implements. Finally, according to another embodiment of the present invention, the bucket is a paint can.

The descriptions, examples and embodiments described herein are presented in order to more fully illustrate preferred embodiments of the invention. They should in no way be construed, however, as limiting the broad scope of the invention. While the invention is described and illustrated herein by references to various specific material, procedures and examples, it is understood that the invention is not restricted to the particular material combinations of material, and procedures selected for that purpose. Numerous variations of such details can be implied as will be appreciated by those skilled in the art.

### REFERENCES

1. U.S. Pat. No. 6,010,299 (the '299 patent), issued Jan. 4, 2000, “Lifting And Positioning Device”;

2. U.S. Pat. No. 6,000,574 (the '574 patent), issued Dec. 14, 1999, “Painting Utensil Mount For Attachment To Paint Containers”;

3. U.S. Pat. No. 5,979,856 (the '856 patent), issued Nov. 9, 1999, “Music Stand”;

4. U.S. Pat. No. 5,979,854 (the '854 patent), issued Nov. 9, 1999, “Strut Apparatus For Holding Drywall Panels And Building Materials In Position”;

5. U.S. Pat. No. 5,885,145 (the '145 patent), issued Mar. 23, 1999, “Powered Drywall Sander And Painter”;

6. U.S. Pat. No. 5,048,796 (the '796 patent), issued Sep. 17, 1991, “Sheet Rock Repair Jack”;

7. U.S. Pat. No. 4,928,916 (the '916 patent), issued May 29, 1990, “Ceiling Panel Installation Support With Telescoping Panel Rest For Ease Of Carrying”; and

8. U.S. Pat. No. 29,311 (the '311 patent), issued Jul. 17, 1977, “Painting Apparatus”.

What is claimed is:

1. A bucket support device comprising:
a. a stand;
b. a vertically disposed central telescoping rod, the rod comprising a first end attached to the stand, and a second end;
c. a horizontally disposed flat support platform, the support platform comprising a bottom surface stably attached to second end of the rod, and a top surface;
d. a bucket comprising a horizontal base and vertical side walls, the bucket horizontal base stably attached to the top surface of the support platform by a bucket attachment means; and
e. a bucket attachment means.

2. The bucket support device according to claim 1, wherein the stand comprises a plurality of legs.

3. The bucket support device according to claim 1, wherein the stand is a tripod.

4. The bucket support device according to claim 1, wherein the stand is retractable.

5. The bucket support device according to claim 1, wherein the stand is collapsible.

6. The bucket support device according to claim 2, wherein each leg comprises a plurality of leg segments, telescopically connected.

7. The bucket support device according to claim 1, wherein the stand is attached to a central ring.

8. The bucket support device according to claim 1, wherein the stand further comprises a plurality of rollers.

9. The bucket support device according to claim 8, further comprising a braking device.

10. The bucket support device according to claim 1, wherein the stand further comprises a plurality of stoppers.

11. The bucket support device according to claim 1, wherein the central telescoping rod further comprises a plurality of rod segments, telescopically connected.

12. The bucket support device according to claim 1, wherein the central telescoping rod further comprises a rod slide-stabilizing device, capable of securing the vertical position of the telescoping rod at a specific position.

13. The bucket support device according to claim 1, wherein the horizontally disposed flat support platform further comprises a central opening compatible with the bucket attachment means.

14. The bucket support device according to claim 1, wherein the horizontally disposed flat support platform further comprises a plurality of openings.

15. The bucket support device according to claim 1, wherein the horizontally disposed flat support platform is a washer.

16. The bucket support device according to claim 1, wherein the bucket further comprises a liner insert.

17. The bucket support device according to claim 16, wherein the liner further comprises a storage compartment.

18. The bucket support device according to claim 1, wherein the bucket is a paint can.
